(19) United States
(12) Patent Application Publication
(10) Pub. No.: US 2022/0114415 A1
(43) Pub. Date: Apr. 14, 2022

(54) ARTIFICIAL NEURAL NETWORK ARCHITECTURES FOR RESOURCE-CONSTRAINED APPLICATIONS

(71) Applicant: AIZIP Inc., Saratoga, CA (US)

(72) Inventors: Yubei CHEN, Emeryville, CA (US); Yuan Mateo LU, Saratoga, CA (US)

(73) Assignee: AIZIP, Inc., Saratoga, CA (US)

(21) Appl. No.: 17/492,653

(22) Filed: Oct. 3, 2021

Related U.S. Application Data
(60) Provisional application No. 63/087,288, filed on Oct. 4, 2020.
(60) Provisional application No. 63/121,951, filed on Dec. 6, 2020.

(51) Int. Cl. G06N 3/04

(52) U.S. Cl. CPC G06N 3/04

(57) ABSTRACT

Aspects of the present disclosure describe improved artificial neural network architectures for resource constrained application that employ tiny skips or improved parameter efficiency of existing artificial neural network architectures designed for resource-constrained applications by employing content-based interaction layers. Our technique is demonstrated with a specific example in which we replace spatial convolution layers in a MobilenetV2-like structure with Lambda Layers and achieve a significant improvement in accuracy while using the same number of parameters. Our disclosed technique(s) will allow the construction of smaller models while achieving the same accuracy for resource-constrained AI applications

### CROSS REFERENCE

This disclosure claims the benefit of U.S. Provisional Patent Application Ser. No. 63/087,288 filed 4 Oct. 2020 and U.S. Provisional Patent Application Ser. No. 63/121,951 filed 6 Dec. 2020 the entire contents of each is incorporated by reference as if set forth at length herein.

### TECHNICAL FIELD

This disclosure relates generally to artificial neural networks. More particularly it pertains to improved artificial neural network architectures and implementation methods that automatically change a given neural network into a smaller/more-efficient arrangement that advantageously provide superior performance in—for example—resource-constrained applications.

### BACKGROUND

As is known in the art, artificial neural networks continue to advance in capability and provide useful solutions to real-world problems including, but not limited to, natural language processing, image detection, fraud detection, and autonomous driving. As is known further, such advances come at enormous resource cost in computing resources and energy consumption.

### SUMMARY

An advance in the art is made according to aspects of the present disclosure directed to artificial neural network architectures, configurations, structures and methods that improve existing resource consumption thereby permitting application of neural networks to new problems that heretofore would be impossible/impractical due to resource constraints.

In sharp contrast to the prior art and according to aspects of the present disclosure, artificial neural networks according to aspects of the present disclosure transform long skips into a series of short (tiny) skips, an input tensor's memory can be released much earlier. Surprisingly, our inventive approach strategy effectively reduces peak runtime memory as compared with other neural networks employing multi-layer (long) skips.

According to further aspects of the present disclosure or improved parameter efficiency of existing artificial neural network architectures designed for resource-constrained applications by employing content-based interaction layers. Our technique is demonstrated with a specific example in which we replace spatial convolution layers in a MobilenetV2-like structure with Lambda Layers and achieve a significant improvement in accuracy while using the same number of parameters. Our disclosed technique(s) will allow the construction of smaller models while achieving the same accuracy for resource-constrained AI applications

### BRIEF DESCRIPTION OF THE DRAWING

A more complete understanding of the present disclosure may be realized by reference to the accompanying drawing in which:

FIG. 1 shows a schematic diagram of a simplified prior art artificial neural network arrangement employing a linear function to mix information between different layers such as a convolution layer using a fixed weighing kernel for all input locations and point-wise non-linearity is oftentimes added after the linear operation, but does not contribute to mixing of information between locations;

FIG. 2 shows a schematic diagram of a simplified artificial neural network arrangement employing content-based interaction according to aspects of the present disclosure wherein content-based interaction layer mixes information between locations depending on the content of input;

FIG. 3 shows a schematic diagram of a simplified artificial neural network arrangement employing a lambda layer according to aspects of the present disclosure;

FIG. 4(A) and FIG. 4(B) are schematic diagrams of simplified, illustrative artificial neural network architecture(s) wherein: FIG. 4(A) shows a neural network without skips and FIG. 4(B) shows a neural network with tiny skips according to aspects of the present disclosure;

FIG. 5A) and FIG. 5(B) are schematic diagrams of simplified, illustrative artificial neural network architecture(s) wherein: FIG. 5(A) shows a neural network without skips, one layer highlighting that once a corresponding input tensor computation is finished memory may be released and FIG. 5(B) shows a neural network with tiny skips according to aspects of the present disclosure highlighting that an input tensor cannot be released before it is added;

FIG. 6(A) and FIG. 6(B) are schematic diagrams of simplified, illustrative artificial neural network architecture(s) in which long skip connections are converted into tiny skip connections wherein: FIG. 6(A) shows a neural network with skips and FIG. 6(B) shows a neural network with tiny skips according to aspects of the present disclosure; and

FIG. 7(A) and FIG. 7(B) are schematic diagrams of simplified, illustrative artificial neural network architecture(s) in which a method for long skip connections converted into tiny skip connections wherein: FIG. 7(A) shows a neural network with skips and FIG. 7(B) shows a modified neural network with tiny skips according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale. Finally, certain phrases and terminology may be used interchangeably in this specification. For example, neural network may be sometimes used instead of artificial neural network.

By way of some additional background, we begin by noting that artificial neural networks—oftentimes simply called neural networks—are computing systems inspired by biological neural networks that constitute animal brains. An artificial neural network is based on a collection of units, or nodes, called artificial neurons, which loosely model neurons in a biological brain.

As those skilled in the art will readily understand and appreciate, artificial neural networks are machine learning models that include one or more layers. Each layer performs a combination of parameterized linear and non-linear functions that together, can represent complex functions. Parameters in an artificial neural network can be optimized so that the artificial neural network performs challenging tasks that require the processing of high-dimensional signals.

The application of artificial neural networks in resource-constrained systems and devices such as mobile phones, smart appliances, and internet of things (IoT) computing devices embedded in everyday objects is becoming increasingly important. Resource constraint(s) of such systems and devices manifests primarily in two ways namely, computing power and storage space. Those skilled in the art will appreciate that while computing power (i.e., speed of computation) can be adjusted by selective latency, storage space—especially on embedded systems—is generally a hard, fixed constraint that will eventually limit the capability of a deployed artificial neural network.

As those skilled in the art will further understand and appreciate, the representation power of an artificial neural network is related to the ability of the neural network to assign proper labels to a particular instance and create well-defined, accurate decision boundaries for a class. Such representation power depends not only on the number of parameters, but it also strongly depends on how the functions in each layer utilize the parameters. The specific forms of the functions are usually referred to as the architecture of the neural network. Accordingly, one way to improve artificial neural network performance operating on resource-constrained devices is to reconfigure the artificial neural network architecture to use parameters more efficiently. As we shall show and describe further, our inventive disclosure that employs content-based interaction layers achieves this very result.

Existing deep neural network architectures—i.e., those having multiple layers between an input layer and an output layer—designed for resource-constrained devices generally employ a “standard” architecture including a linear function followed by a point-wise non-linear function. Examples of those layers include fully connected layers and convolutional layers. Those skilled in the art will recognize that a fully connected layer is a one where all inputs from one layer are connected to every activation unit of a next layer while a convolution layer applies a convolution operation to an input, passing the result to the next layer.

As noted, according to one aspect of the present disclosure we describe the apply content-based interaction layers to artificial neural networks designed for resource-constrained applications. Prominent examples of such artificial neural networks that may advantageously benefit from our disclosure include MobileNets—based on a streamlined architecture that use depth-wise separable convolutions to build light weight, deep artificial networks—described by M. Sandler, A. Howard, M. Zhu, A. Zhmoginov, and L. C. Chen, in a paper entitled “Mobilenetv2: Inverted Residuals and Linear Bottlenecks”, that appeared in Proceedings of the IEEE Conference on Computer Vision and Pattern Recognition, pp. 4510-4520, 2018; and another paper authored by A. Howard, M. Sandler, G. Chu, L. C. Chen, B. Chen, M. Tan, W. Wang, Y. Zhu, R. Pang, V. Vasudevan, entitled “Searching for MobileNetv3”, that appeared in Proceedings of the IEEE/CFV International Conference on Vision, pp. 1314-1324, 2019. Still other network architectures that may benefit from modification(s) according to the present disclosure include—but are not limited to—Squeezenet (described by F. N. Iandola, S. Han, M. W. Moskewicz, K. Ashraf, W. J. Dally, and K. Keutzer, in a paper entitled “Squeezenet: Alexnet-Level Accuracy with 50× Fewer Parameters and; 0.5 mb Model Size”, arXiv preprint arXiv:1602.07360, 2016); ResNet (described by K. He, X. Zhang, S. Ren, and J. Sun, in a paper entitled “Deep Residual Learning for Image Recognition”, which appeared in Proceedings of the IEEE Conference on Computer Vision and Pattern Recognition, pp. 770-778, 2016; and EfficientNet (described by M. Tan, and Q. Le, “EfficientNet: Rethinking Model Scaling for Convolutional Neural Networks”, which appeared in International Conference on Machine Learning, pp. 6105-6114, PMLR, 2019). Finally, we note that a special case has been shown wherein only content-based interaction layers are employed in an artificial neural network as described by A. Dosovitskiy, L. Beyer, A. Kolesnikov, D. Weissenborn, X. Zhai, T. Unterthiner, M. Dehghani, M. Minderer, G. Heigold, S. Gelly, in a paper entitled: “An Image is Worth 16×16 Words: Transformers for Image Recognition at Scale”; that appeared in arXiv preprint arXiv:2010.11929, 2020.

As is known, content-based interaction layers generally employ a mechanism that enables flexible information routing between locations in an activation map than standard, fully connected layers and convolution layers.

In a convolution layer, a convolution operation with a fixed kernel is applied to the activation map, then the output is generated by applying a point-wise non-linear activation function. In other words, information is mixed between activation at different locations using a learned fixed pattern encoded by the convolutional weights.

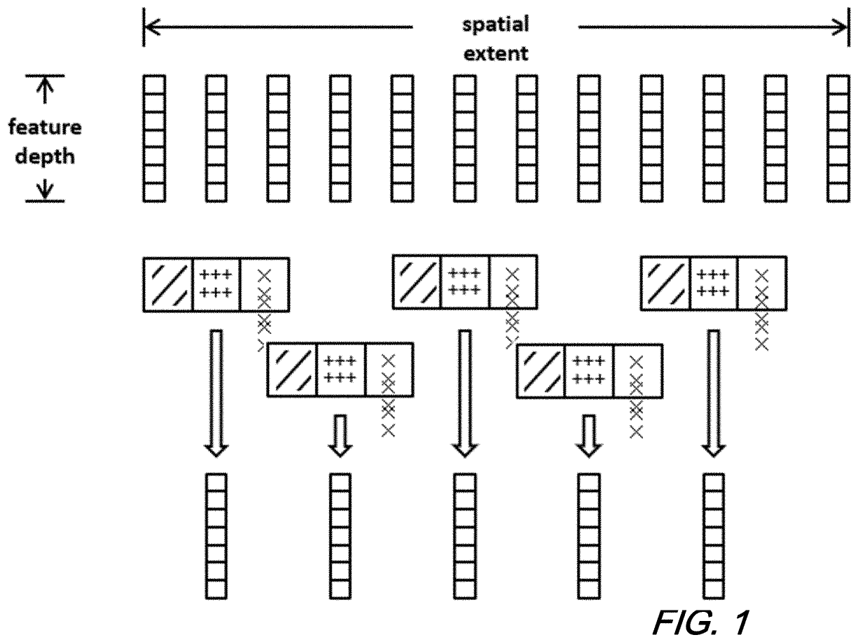

The operation of a convolution layer is illustrated in FIG. 1 which shows a schematic diagram of a simplified prior art artificial neural network arrangement employing a linear function to mix information between different layers, for example a convolution layer using a fixed weighing kernel for all input locations. Highlighted in the figure is the spatial extent and feature depth. In such an arrangement, a point-wise non-linearity is oftentimes added after the linear operation, but it does not contribute to mixing of information between locations.

In content-based interaction, instead of mixing information with the fixed weights, the interaction weights are computed based on other inputs, or the input itself. This allows much more complex interactions between the activation, making those interactions more flexible than the linear operation used in convolutions. Additionally, content-based interaction can also encode long-range interaction with much fewer parameters and computation compared to the convolution architectures. This enables the use of global interaction or a much larger local context of interaction, making them more powerful than convolution architectures. Indeed, recent research has shown that content-based interaction layers can completely replace convolutions and achieve better performance.

As those skilled in the art will understand and appreciate, self-attention is a most prominent example of content-based interaction layers. Its introduction brought a great leap in performance to natural language processing, and later, self-attention was adopted for use in computer vision tasks. We note that the term attention is very broadly and vaguely defined in the art. It can refer to any mechanism where part of the input is selected over others dynamically.

Mechanisms that are referred to as attention include Self-attention, Transformer, Non-local Neural Networks, and Lambda Layers, etc., which can also be considered content-based interaction layers. Occasionally, even Squeeze and Excitation modules (SE) are referred to as an attention mechanism. For our purposes, we do not consider SE to be a content-based interaction layer, as the mechanism is best described as a gating process instead of routing. In contrast, self-attention is much more well defined.

To provide more precise definitions according to the present disclosure, in self-attention, input is first linearly projected into key. query and value vectors. Key and query then interact via dot product, the weight between each position pair is computed by normalizing the dot products via a softmax function over spatial positions. Value vectors are then aggregated across spatial positions using the computed weights.

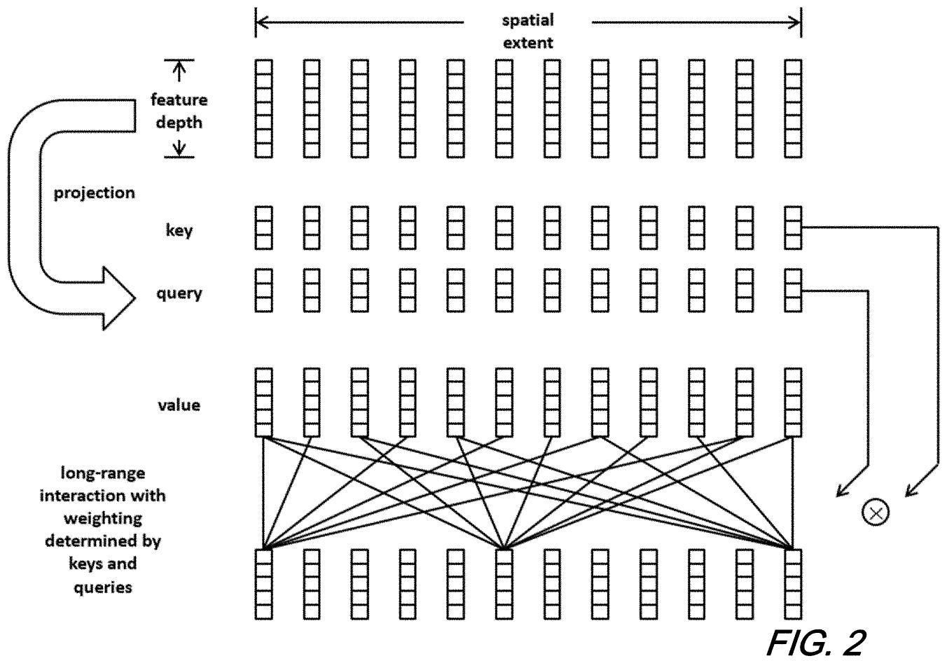

We denote the input as X∈R^{F}^{ᵢₙ}^{×N}, it represents an input sequence of length N and dimension Fᵢₙ. The input can also be a 2D activation map flattened in the spatial dimension having size H×W=N. Key, query and value is generated by applying 3 weight matrices: k=Wₖx, q=W_{q}x, v=Wᵥx, where k,q∈R^{F}^{ₖ}^{×N} and v∈R^{F}^{ᵥ}^{×N}. The output of the self-attention layer is then

$${v}_{out} = v \cdot {softmax}^{( {k}_{q}^{T} )} \qquad ( 1 )$$

Where the softmax function applies to the column direction. We illustrate the operation of a self-attention layer in FIG. 2, which shows a schematic diagram of a simplified artificial neural network arrangement employing content-based interaction according to aspects of the present disclosure wherein content-based interaction layer mixes information between locations depending on the content of input.

In real applications, position encoding is typically added to X to provide additional information. Self-attention alone is sufficiently powerful for a surprisingly large range of machine learning tasks. In computer vision, however, it can also be mixed with standard convolutional architecture for better efficiency.

The self-attention layer is very flexible, and it achieves improved performance compared to convolution architecture when applied to vision tasks. However, it suffers from the drawback of exhibiting O(N²) time and space complexity with respect to the sequence length (or spatial size) N. This complexity limits its efficiency for long sequence or large activation maps. Substantial research effort has been devoted to developing efficient attention mechanisms that circumvent this quadratic complexity.

We note that the use of Lambda layer was inspired by the efficient attention mechanisms, and it is particularly effective in computer vision tasks. The Lambda layer takes input X∈R^{|n|×d}^{ᵢₙ} and context C∈R^{|m|×d}^{_{c}} to produce output Y E R^{|n|×d}^{ₒᵤₜ}. In vision tasks, the context is either a local area near the point of interest, or an entire activation map of a layer. Lambda layer seeks to generate output at a certain position yₙ by applying a matrix computed from the context λₙ∈R^{|k|×|n|} to a linearly generated query qₙ: yₙ=λ^{T}ₙqₙ.

The matrix λₙ is generated by two types of interactions namely, content-based and position-based. The context is first linearly projected into key K and value V, the keys are then normalized in the spatial dimensions (via softmax function) into normalized key K̅. Alone with a learned position embedding Eₙ, the matrix λₙ is computed as:

$${λ}_{n} = {\overline{K}}^{T} V + {E}_{n}^{T} V \qquad ( 2 )$$

Note that the meaning of key, query, and value are different from those in self-attention. The content-based term K̅^{T}V contains aggregates of features from every location, with weighting determined by the content. In some sense, this works similarly as the self-attention mechanism. The position-based term Eₙ^{T}V generates a lambda matrix depending on the content of the context, as well as the relative positions of the activation within the context. In this sense, it is also a type of content-based interaction.

We note that there are two types of position embeddings in the Lambda layer. One is global, which learns position embedding between all location pairs in the activation map. The other is local, which learns a position embedding as a function of relative positions. Local position embedding works very much like a convolution layer.

As has been previously noted, content-based interaction layers when employed in artificial neural networks provide at least two advantages. First, they are more flexible, which makes the network architecture more expressive. Second, they outperform the convolution layers with the same parameter count, although sometimes they require more computation.

We note at this point that it is possible to replace all layers in a convolutional neural network with content-based interaction layers, but higher efficiency may be achieved by mixing convolution layers and content-based interaction layers.

Those skilled in the art will recognize that artificial neural networks used in vision tasks typically extract short-range local features in earlier layers and process long-range global features in later layers. As such, and according to aspects of the present disclosure, content-based interaction layers such as self-attention and Lambda layer with global context may be particularly suited for replacing later layers in a convolutional neural network. If, on the other hand, one wishes to replace earlier layers with a self-attention or Lambda layer, then a limited local context should be used to reduce the computational burden. Indeed, this is a strategy proposed in previous work.

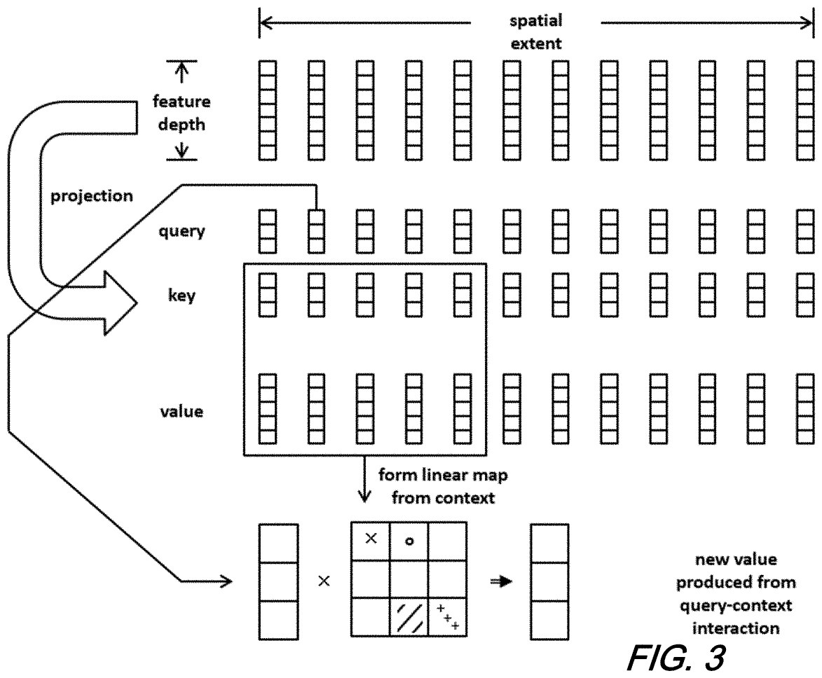

FIG. 3 shows a schematic diagram of a simplified artificial neural network arrangement employing a lambda layer according to aspects of the present disclosure. As may be observed from that figure, query, key, and value vectors are computed from input features. Then, linear functions, lambdas, are constructed for each location depending on the content of the context. The lambda then acts on query to produce an output for that location.

We note that when applying modifications according to the present disclosure, content-based interaction layers should be used to replace layers that allow interaction between different locations in the feature map. In, for example, ResNet, this will be a 3×3 convolution layer in the residual block, the 1×1 convolutions are position-wise operations thus are left unchanged. Similarly, in MobileNet, depth-wise separable convolution layer can be replaced by a content-based interaction layer.

To demonstrate the usefulness of content-based interaction layers in a resource-constrained application, we show that the Lambda layer can improve the performance of MobileNet with a similar parameter count.

Our baseline model architecture is based on MobileNetV2 and MobileNetV3. We employ the above-described strategy and replace all depth-wise convolution layers in the last 3 resolution stages with Lambda layers, which have local context. Blocks that change channel count are left unchanged. The size of a local context is 5×5 for the last resolution stage, and 9×9 for other stages. We chose the specific network by searching baseline architecture space with neural architecture search technique (NAS) and using the same structural parameters (expansion, depth, etc.) for the modified network. After the modifications, the parameter count is within 2% of the baseline network.

We trained both models on ImageNet for 90 epochs on 4 GPUs and simply compare the vest validation accuracy attained during the training process. We used the same hyper-parameters: learning rate, 0.3, batch size 768, dropout 0.1. The baseline model achieves 67.70% accuracy (best over 3 runs) while the network modified with Lambda layer achieves 69.08% (best over 3 runs)—a more than 1.3% increase, which those skilled in the art will appreciate is quite significant for the ImageNet dataset.

At this point we now describe another aspect of the present disclosure directed to our inventive artificial neural network architecture in which numerous short skip connections are used to further improve the accuracy a deep neural network.

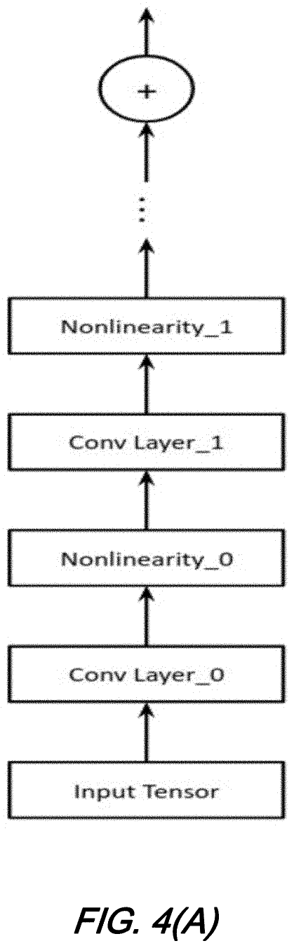

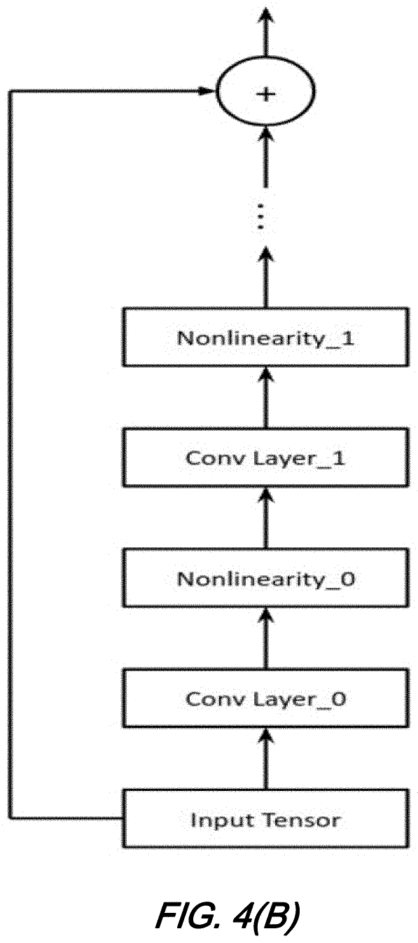

FIG. 4(A) and FIG. 4(B) are schematic diagrams of simplified, illustrative artificial neural network architecture(s) wherein: FIG. 4(A) shows a neural network without skips and FIG. 4(B) shows a neural network with tiny skips according to aspects of the present disclosure.

As those skilled in the art will appreciate, skip connections may advantageously provide a level of accuracy to a neural network. Perhaps the most famous example of such skips are residual networks. As noted, FIG. 4(A) illustrates a convolutional neural network without skip connection while FIG. 4(B) illustrates a similar neural network having a skip connection.

Although a residual network has many advantages over traditional pipeline style networks, there nevertheless is a major drawback to using a skip connection neural network in a memory constrained situation. Note that without a skip connection, the input tensor to a layer is no longer needed once the layer's computation is finished. In fact, since the dependency granularity is much finer than a whole layer, one can start to throw away the corresponding portion of the input tensor once its computation is finished. As a result, for the network in the figure, the memory footprint of the computation is
˜max(size(input tensor), size(Conv Layer_0), size(NonLinearity_0), . . . )

In other words, the memory footprint is determined by the “widest” layer alone.

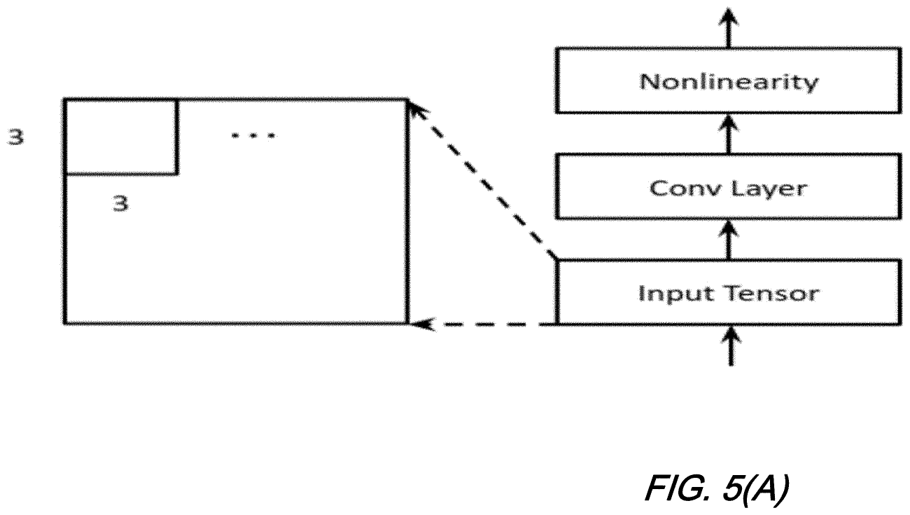

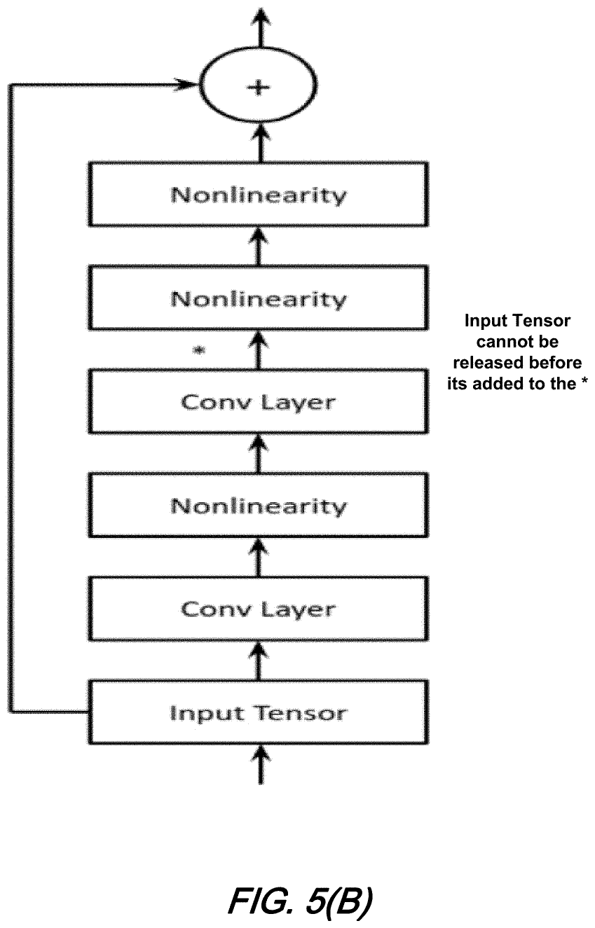

FIG. 5A) and FIG. 5(B) are schematic diagrams of simplified, illustrative artificial neural network architecture(s) wherein: FIG. 5(A) shows a neural network without skips, one layer highlighting that once a corresponding input tensor computation is finished memory may be released and FIG. 5(B) shows a neural network with tiny skips according to aspects of the present disclosure highlighting that an input tensor cannot be released before it is added.

As is illustratively shown in FIG. 5(A), for a neural network without a skip connection, once a corresponding input tensor computation is finished, memory used for that computation may be released.

However, once a skip connection is used, one can no longer throw away the input tensor easily as the input tensor will be needed later to be added to the output tensor of a latter layer, which is typically several stages later (FIG. 5 (B)). As a result, the input tensor must be kept in the memory until all of its computation is finished. Using the network illustrated in FIG. 5(A) as an example, the memory footprint of the computation is
˜size(input tensor)+max(size(Conv Layer_0), size(NonLinearity_0), size(Conv Layer_1), . . . ).

In memory rich situations, this is not a problem. But when the memory size is a constraint, this will introduce an extra limit to the model space selection. For example, in many embedded systems, RAM quantity is quite small and such a constraint would significantly limit our model's performance since if the peak runtime memory is larger than the device's constraint, then the model can not be executed. Practically, when skip connections are used, in order to build an inference model runnable on the device, one needs to shrink the activation map (tensors) during the execution to make sure it fits into the memory. That often results in significant loss of accuracy.

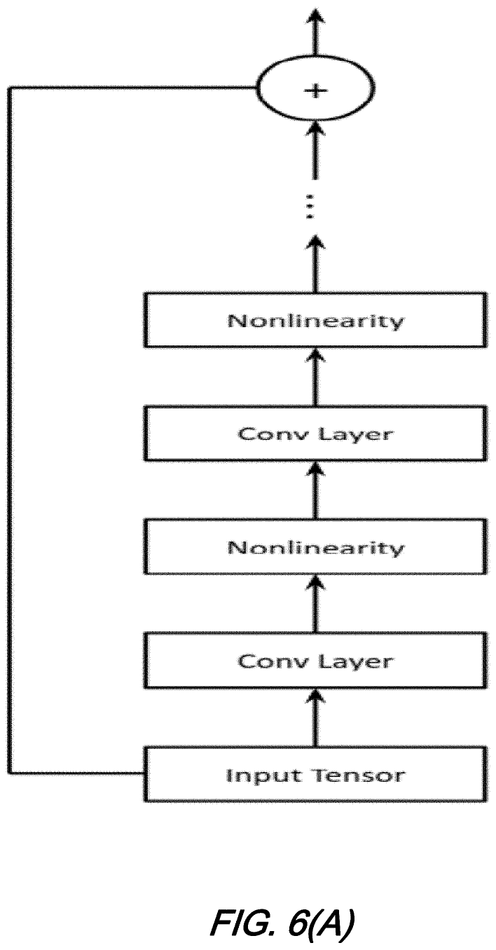

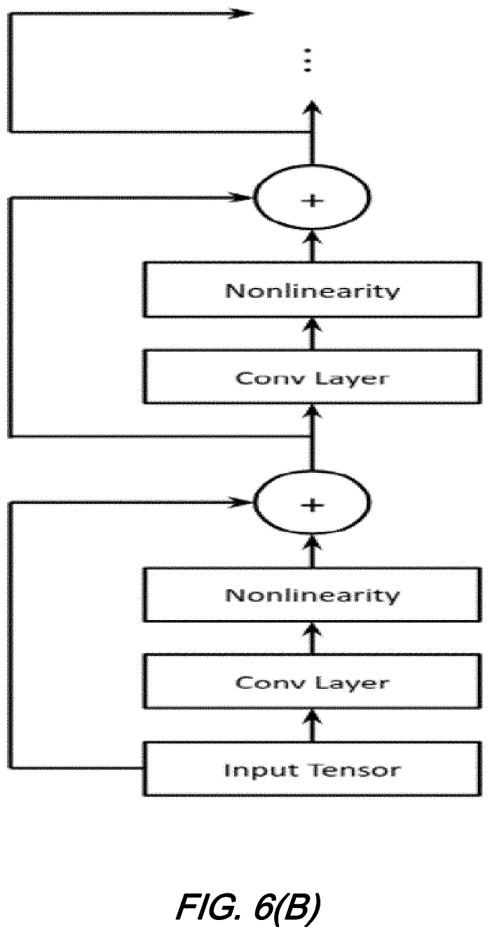

According to aspects of the present disclosure, our inventive architecture(s) and approach(es) advantageously alleviate memory issue(s) of skip connections namely, we replace long skip connections with the short ones, especially for the ones, which cause the peak runtime memory. One important insight is that the input tensor is not needed to be kept when the skip connection is just over a typical convolutional layer+an activation layer. Therefore, for a skip connection skip more than two linear layers, we can turn it into shorter ones. In the following, we show how one can turn a NN with long skip connections to tiny skip connections in FIG. 6(A) and FIG. 6(B).

FIG. 6(A) and FIG. 6(B) are schematic diagrams of simplified, illustrative artificial neural network architecture(s) in which long skip connections are converted into tiny skip connections wherein: FIG. 6(A) shows a neural network with long skips and FIG. 6(B) shows a neural network with tiny skips according to aspects of the present disclosure.

As may be observed, once the long skips have been turned into a series of short (tiny) skips, the input tensor's memory can be released much earlier. Accordingly, our inventive approach strategy can effectively reduce peak runtime memory to
˜max(size(input tensor), size(output tensor)) again.

Since our operation basically replaces the long skip connection by a series of short skip connections (tiny skips), we can call this a tiny skip connection. As illustrated, the long skip encompasses a plurality of cony layer(s) and nonlinearity layer(s). In sharp contrast, the tiny skips that replace the long skip may only include a single cony. Layer and nonlinearity layer. Surprisingly, such increased overhead results in an improved performance.

With this understanding, our inventive architecture(s) may be automatically produced by a method that converts a long skip connection network into a tiny skip connection network as follows. Note that we assume the given network's memory footprint is lower than Total Memory limit without skip connection.

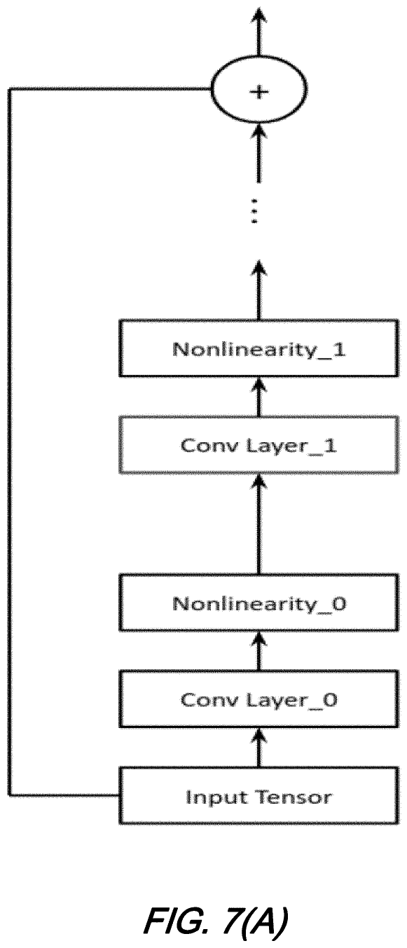

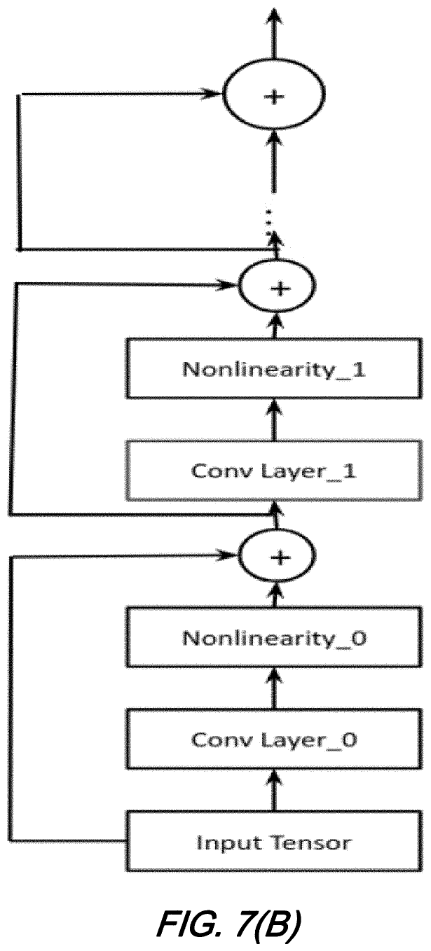

FIG. 7(A) and FIG. 7(B) are schematic diagrams of simplified, illustrative artificial neural network architecture(s) in which a method for long skip connections converted into tiny skip connections wherein: FIG. 7(A) shows a neural network with skips and FIG. 7(B) shows a modified neural network with tiny skips according to aspects of the present disclosure.

convert(network):

```
For each layer, compute the peak memory needed for that layer and save
them in an array
  Layer i is the layer with max memory footprint (highlighted layer)
  If memory footprint of Layer i is smaller than TotalMemoryLimit,
      quit(SUCCESS)
    else
      assert (skip connection found)
      break the skip connection over the layer into 3 segments:
        change the original skip connection stop before this affected
        layer
        add a new skip connection over the affected layer and its
      activation layer
        add a new skip connection starting the activation layer until
    previous skip connection stop layer
    go to first step
```

At this point, while we have presented this disclosure using some specific examples, those skilled in the art will recognize that our teachings are not so limited. Accordingly, this disclosure should be only limited by the scope of the claims attached hereto.

1. A method of improving parameter efficiency of an artificial neural network, the method comprising:
providing the artificial neural network comprising an input layer, an output layer and a plurality of convolution layers interposed between the input layer and the output layer,
replacing all depthwise convolutions with content-based interaction layer(s).

2. The method of claim 1 wherein a replacement content-based interaction layer is located immediately preceeding the output layer.

3. A method comprising:
providing the artificial neural network comprising an input layer, an output layer and a plurality of convolution layers interposed between the input layer and the output layer, the provided artificial neural network including a skip that bypasses a plurality of the convolution layers (long skip); and
replacing the long skip with a plurality of short skips wherein each short skip bypasses only a single convolutional layer of the plurality of convolution layers.

4. An artificial neural network architecture comprising:
an input layer,
an output layer,
a plurality of convolution layers interposed between the input layer and the output layer, and
one or more skips that bypass one or more of the convolution layers such that each skip bypasses only a single one of the plurality of convolution layers.
